(19) United States
(12) Patent Application Publication
(10) Pub. No.: US 2013/0268151 A1
(43) Pub. Date: Oct. 10, 2013

(54) COOLING FAN CONTROL DEVICE

(71) Applicant: SUZUKI MOTOR CORPORATION, Shizuoka-ken (JP)

(72) Inventor: Seiji Bito, Hamamatsu-shi (JP)

(73) Assignee: SUZUKI MOTOR CORPORATION, Shizuoka-ken (JP)

(21) Appl. No.: 13/801,692

(22) Filed: Mar. 13, 2013

(30) Foreign Application Priority Data
Apr. 6, 2012 (JP) 2012-087041

(51) Int. Cl. B60W 20/00; B60W 10/30

(52) U.S. Cl. CPC B60W 20/00; B60W 10/30; Y10S 903/904
USPC 701/22; 903/904

(57) ABSTRACT

A cooling fan control device for use in a vehicle in which a drive battery and an engine, both serving as drive energy sources, and an air conditioner of the vehicle are mounted, and in which a cooling fan for cooling the drive battery is provided, is disclosed. Cooling fan control means, which includes first drive condition determination means, second drive condition determination means, third drive condition determination means, and fourth drive condition determination means, compares the largest drive amount among drive amounts of a cooling fan which are respectively obtained by the second drive condition determination means, the third drive condition determination means, and the fourth drive condition determination means, with a drive amount of the cooling fan which is obtained by the first drive condition determination means, and drives the cooling fan in correspondence with the smaller drive amount of the cooling fan.

### CROSS-REFERENCE TO RELATED APPLICATION

The present application claims priority from Japanese Patent Application No. 2012-087041 filed Apr. 6, 2012, the disclosure of which is hereby incorporated herein by reference.

### BACKGROUND OF THE INVENTION

The present invention relates to a cooling fan control device, and more particularly, relates to a cooling fan control device which cools a drive battery in an electric vehicle equipped with the drive battery and an engine as drive energy sources as in a hybrid vehicle and a plug-in hybrid vehicle.

In an electric vehicle equipped with a drive battery and an engine as drive energy sources as in a hybrid vehicle or a plug-in hybrid vehicle, the temperature of the battery is likely to increase during charging and discharging of a large current and reaches, in a short time, a temperature (for example, 50° C.) at which the durability of the battery is deteriorated. Since the durability of the drive battery is likely to be deteriorated at a relatively high temperature (for example, 50° C.), it is necessary to cool the drive battery by driving a cooling fan at the time when the battery temperature reaches around a predetermined temperature (for example, 40° C.).

Examples of the drive condition of the cooling fan include cases, such as a case in which a predetermined condition based on the battery temperature and on the vehicle speed is established, and a case in which a predetermined condition based on the battery temperature and on the load of an air-conditioner is established.

A fan controller of a hybrid vehicle according to Japanese Patent Publication No. 2001-103612 is configured such that, when it is estimated that the idle stop is to be performed, a cooling fan is stopped before the idle stop is performed, and such that the air volume of the cooling fan is reduced to zero after the lapse of a predetermined time.

A battery cooling system for a vehicle according to Japanese Patent Publication No. 10-306722 is configured to cool a battery in such a manner that, on the basis of states, such as an air-conditioner operation state, an air conditioning state in the vehicle compartment, and a battery temperature state, a cooling fan and a switching damper are controlled while a pressure drop in the vehicle compartment and an increase in the air conditioning load are reduced.

Meanwhile, even when the battery temperature reaches the predetermined temperature at which the cooling fan is to be driven, there may be a case in which the condition to allow the cooling fan to be driven is not established only by the vehicle speed condition and the air conditioning condition, and a case in which the drive battery cannot be efficiently cooled.

However, the '612 Japanese Patent Publication described above has a disadvantage in that, when the vehicle speed is low, the air volume of the cooling fan cannot be increased, and hence the cooling efficiency of the drive battery is low. Furthermore, the '722 Japanese Patent Publication described above has a disadvantage in that, when the air conditioning is not performed, the drive battery cannot be cooled.

### BRIEF SUMMARY OF THE INVENTION

An object of the present invention is to provide a cooling fan control device which enables a cooling fan for cooling a drive battery of a vehicle to be driven in the state in which the driving sound of the cooling fan is hardly perceived by an occupant of the vehicle, and which can promote the cooling of the drive battery by increasing opportunities for enabling the driving of the cooling fan.

According to the present invention, there is provided a cooling fan control device for use in a vehicle in which a drive battery and an engine, both serving as drive energy sources, and an air conditioner of the vehicle are mounted, and in which a cooling fan for cooling the drive battery is provided, the cooling fan control device being characterized by including: temperature measurement means for detecting a temperature of the drive battery; blower fan drive amount detection means for detecting a drive amount of a blower fan of the air conditioner; vehicle speed detection means for detecting a vehicle speed; engine speed detection means for detecting an engine speed; and cooling fan control means provided with first drive condition determination means for obtaining a drive amount of the cooling fan according to the temperature of the drive battery, second drive condition determination means for obtaining a drive amount of the cooling fan according to the drive amount of the blower fan of the air conditioner, third drive condition determination means for obtaining a drive amount of the cooling fan according to the vehicle speed, and fourth drive condition determination means for obtaining a drive amount of the cooling fan according to the engine speed, and characterized in that the cooling fan control means compares the largest drive amount of the cooling fan among the drive amounts of the cooling fan which are respectively obtained by the second drive condition determination means, the third drive condition determination means, and the fourth drive condition determination means, with the drive amount of the cooling fan which is obtained by the first drive condition determination means, and in that the cooling fan control means drives the cooling fan in correspondence with the smaller drive amount of the cooling fan.

According to the present invention, the cooling fan for cooling the drive battery of the vehicle can be driven in the state in which the driving sound of the cooling fan is hardly perceived by an occupant of the vehicle, and the cooling of the drive battery can be promoted by increasing opportunities for enabling the driving of the cooling fan.

### BRIEF DESCRIPTION OF THE DRAWINGS

FIG. 1 is a view showing a system configuration of a cooling fan control device.

FIG. 2 is a flow chart of control of the cooling fan.

FIG. 3(A) is a first map used in first drive condition determination means for obtaining a drive amount of the cooling fan according to a battery temperature.

FIG. 3(B) is a second map used in second drive condition determination means for obtaining a drive amount of the cooling fan according to a drive amount (drive level) of a blower fan.

FIG. 3(C) is a third map used in third drive condition determination means for obtaining a drive amount of the cooling fan according to a vehicle speed.

FIG. 3(D) is a fourth map used in fourth drive condition determination means for obtaining a drive amount of the cooling fan according to an engine speed.

### DETAILED DESCRIPTION

In the present invention, the object of the present invention, which is to enable a cooling fan for cooling a drive battery of a vehicle to be driven in the state in which the driving sound of the cooling fan is hardly perceived by an occupant of the vehicle, and which is to promote the cooling of the drive battery by increasing opportunities for enabling the driving of the cooling fan, is realized in consideration of not only the battery state, the air conditioning state, and the vehicle state, but also the engine state.

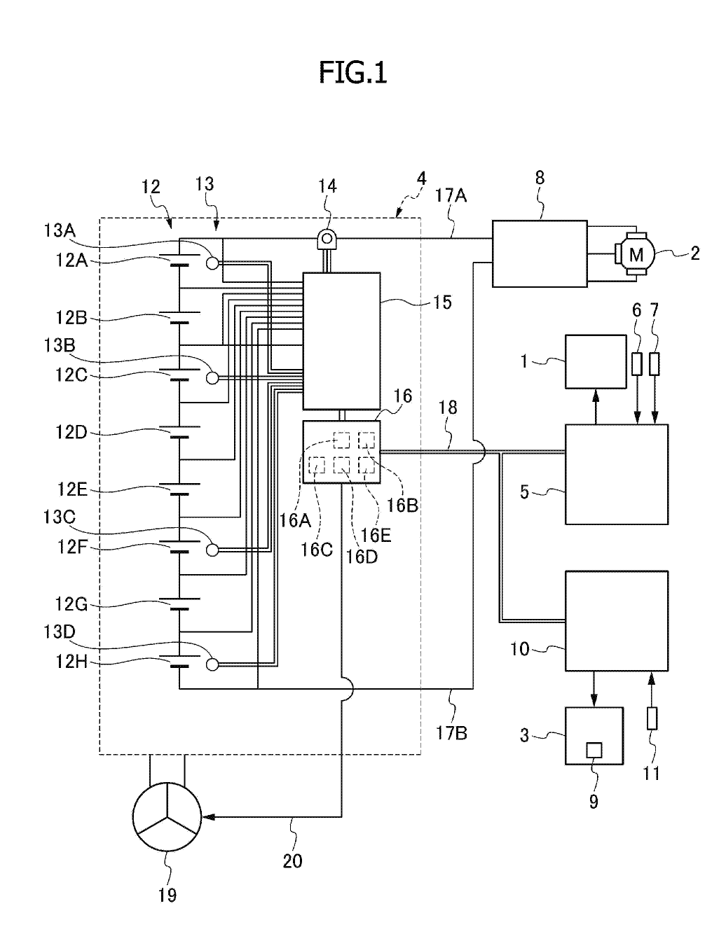

FIGS. 1 to 3 show an example according to the present invention. In FIG. 1, reference numeral 1 denotes an engine mounted in an electric vehicle, such as a hybrid vehicle and a plug-in a hybrid vehicle. Furthermore, the vehicle is equipped with a drive motor 2, an air conditioner 3, and a battery system (battery pack) 4.

The engine 1, which is an internal combustion type engine and which serves as one of drive energy sources of the vehicle, is controlled by engine control means 5. The engine control means 5 is connected to engine speed detection means 6 for detecting, as an engine state, the number of revolutions of the engine 1, and vehicle speed detection means 7 for detecting the vehicle speed as a vehicle state.

The drive motor 2 is connected to an inverter 8 which is a power converter. The inverter 8 converts DC power from the battery system 4 into AC power and outputs the AC power to the drive motor 2.

The air conditioner 3 adjusts the temperature in the vehicle compartment, and includes a blower fan 9. The blower fan 9 is controlled by air conditioning control means 10. The air conditioning control means 10 is connected to blower fan drive amount detection means 11 for detecting, as an air conditioning state, a drive amount (drive level) of the blower fan 9.

The battery system 4 includes a drive battery 12 serving as other drive energy source of the vehicle, battery temperature measurement means 13 for measuring the temperature of the battery, battery current detection means 14 for measuring the current of the battery, battery state detection means 15 connected to the drive battery 12, the battery temperature measurement means 13, and the battery current detection means 14, and cooling fan control means 16 connected to the battery state detection means 15.

The drive battery 12 is formed by a plurality of battery cells, for example, a first battery cell 12A to an eighth battery cell 12H which are connected in series.

The battery temperature measurement means 13 is formed by first to fourth temperature measurement means 13A to 13D which are arranged at predetermined intervals among the first to eighth battery cells 12A to 12H so as to detect, as battery temperatures, the temperatures of the first to eighth battery cells 12A to 12H.

The battery current detection means 14 is provided in the middle of a positive side current line 17A which connects the positive (+) terminal of the drive battery 12 to the inverter 8. Furthermore, the negative (−) terminal of the drive battery 12 is connected to the inverter 8 by a negative side current line 17B.

The battery state detection means 15 detects, as battery states, battery voltages of the first to eighth battery cells 12A to 12H, battery temperatures from the first to fourth temperature measurement means 13A to 13D, and battery current from the battery current detection means 14.

The cooling fan control means 16 is connected to the battery state detection means 15, and is also connected to the engine control means 5 and the air conditioning control means 10 via a communication line 18. Furthermore, the cooling fan control means 16 performs calculation based on the battery states (battery voltage, battery current, battery temperature) detected by the battery state detection means 15, the engine state (engine speed) and the vehicle state (vehicle speed) both detected by the engine control means 5, and the air conditioning state (the drive amount (drive level) of the blower fan 9) detected by the air conditioning control means 10.

Furthermore, the battery system 4 is additionally provided with a cooling fan 19 which is connected to the cooling fan control means 16 and which cools the drive battery 12. The cooling fan control means 16 and the cooling fan 19 are connected to each other by a control line 20.

Furthermore, the cooling fan control means 16 takes therein the battery state, the engine state, the vehicle state, and the air conditioning state, so as to perform calculation to determine a drive amount (drive condition) of the cooling fan 19, and performs drive control (duty control) of the cooling fan 19 on the basis of the determined drive amount of the cooling fan 19, so as to cool the drive battery 12.

In this example, the cooling fan control means 16 includes first drive condition determination means 16A, second drive condition determination means 16B, third drive condition determination means 16C, and fourth drive condition determination means 16D.

In the first drive condition determination means 16A, a drive amount of the cooling fan 19 which represents a drive condition of the cooling fan 19, is obtained according to a battery temperature of the drive battery 12, which temperature represents a battery state. In the second drive condition determination means 16B, a drive amount of the cooling fan 19 which represents a drive condition of the cooling fan 19, is obtained according to a drive amount (drive level) of the blower fan 9 of the air conditioner 3 which represents an air conditioning state. In the third drive condition determination means 16C, a drive amount of the cooling fan 19 which represents a drive condition of the cooling fan 19, is obtained according to a vehicle speed representing a vehicle state. In the fourth drive condition determination means 16D, a drive amount of the cooling fan 19 which represents a drive condition of the cooling fan 19, is obtained according to an engine speed representing an engine state.

Furthermore, in the cooling fan control means 16, the largest drive amount of the cooling fan 19 among the drive amounts of the cooling fan 19 which are respectively obtained by the second drive condition determination means 16B, the third drive condition determination means 16C, and the fourth drive condition determination means 16D, is compared with the drive amount of the cooling fan 19 which is obtained by the first drive condition determination means 16A, and the cooling fan 19 is driven in correspondence with the smaller drive amount of the cooling fan 19.

That is, among the drive conditions of the cooling fan 19, the drive of the cooling fan 19 is permitted not only on the basis of the battery temperature and the drive amount (drive level) of the blower fan 9, but also on the basis of the vehicle speed and the engine speed. In an electric vehicle, when the vehicle is stopped in the state in which the engine 1 is rotated, the background noise is increased due to the operation sound of the engine 1, so as to provide an effect that the driving sound of the cooling fan 19 is not perceived. Here, the background noise is noise which obscures the driving sound of the cooling fan 19, and which corresponds to the driving sound of the blower fan 9, the wind noise caused by the travelling of the vehicle, the road noise, and the operation sound of the engine. The sound caused by opening and closing the window, and the audio sound may also be considered as the background noise. Furthermore, in this example, even when the components are arranged so that the drive battery 12 is overheated by the heat of a silencer, the drive battery 12 can be prevented from being heated to a high temperature.

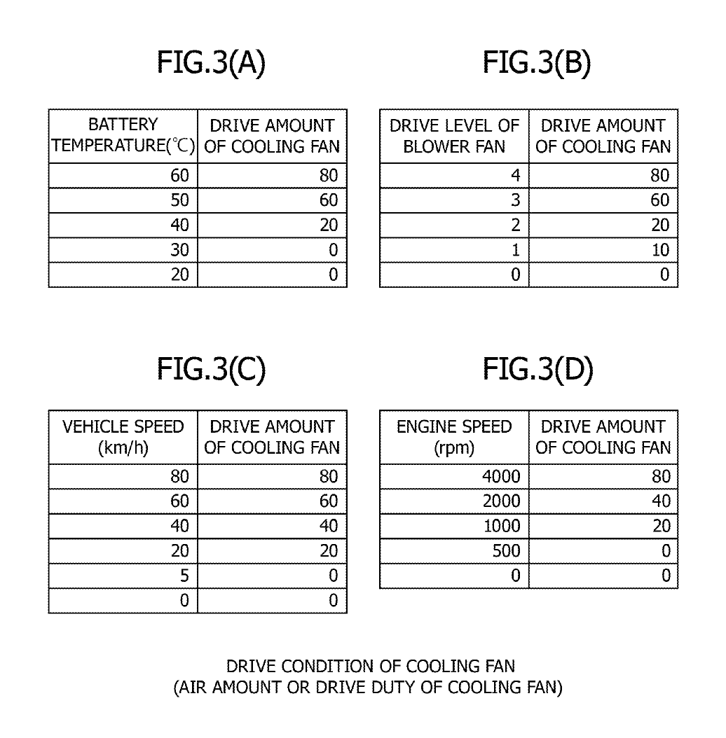

As the drive conditions of the cooling fan 19 (the wind amounts or the duty values for driving the cooling fan 19), storage means 16E of the cooling fan control means 16 stores, for example, as shown in FIG. 3, a first map (A) used in the first drive condition determination means 16A for obtaining a drive amount of the cooling fan 19, a second map (B) used in the second drive condition determination means 16B for obtaining a drive amount of cooling fan 19, a third map (C) used in the third drive condition determination means 16C for obtaining a drive amount of cooling fan 19, and a fourth map (D) used in the fourth drive condition determination means 16D for obtaining a drive amount of cooling fan 19. Numerical values between respective values in each of the maps of the first map (A) to the fourth map (D) are linearly interpolated (on the basis of an interpolation method for obtaining numerical values under the consideration that the numerical values between the respective values are linearly changed).

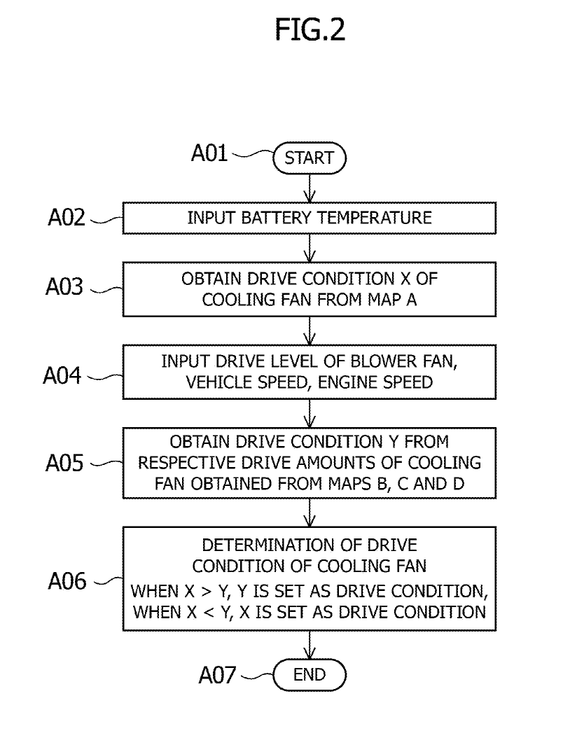

Next, the control of the cooling fan 19 according to this example will be described on the basis of a flow chart shown in FIG. 2.

As shown in FIG. 2, when a program of the cooling fan control means 16 is started (step A01), first, a battery temperature measured by the battery temperature measurement means 13 is inputted (step A02). Then, according to the battery temperature, a predetermined drive condition X (a drive amount of the cooling fan 19 based on the battery temperature) is obtained from the first map (A) stored in the storage means 16E (step A03).

Then, a drive amount (drive level) of the blower fan 9 detected by the blower fan drive amount detection means 11, a vehicle speed detected by the vehicle speed detection means 7, an engine speed detected by the engine speed detection means 6 are input (step A04).

Then, according to the input drive amount (drive level) of the blower fan 9, a drive amount of the cooling fan 19 as a drive condition is obtained from the second map (B) stored in the storage means 16E, and further, according to the inputted vehicle speed, a drive amount of the cooling fan 19 as a drive condition is obtained from the third map (C) stored in the storage means 16E. Furthermore, according to the inputted engine speed, a drive amount of the cooling fan 19 as a drive condition is obtained from the fourth map (D) stored in the storage means 16E (step A05). Then, among these drive amounts of the cooling fan 19, the largest drive amount is adopted, so as to be set as a drive condition Y.

Subsequently, the drive condition X obtained according to the battery temperature is compared with the drive condition Y obtained as the largest drive amount of the cooling fan 19, that is, it is determined whether X>Y or X<Y, and the smaller drive condition between the drive condition X and the drive condition Y is adopted as a drive condition for driving the cooling fan 19 (step A06). Specifically, when X>Y, the drive condition Y is adopted. On the other hand, when X<Y, the drive condition X is adopted. Then, the cooling fan 19 is driven on the basis of the adopted drive condition (X or Y). Thereby, the cooling fan 19 can be driven in the state in which the driving sound of the cooling fan 19 is hardly perceived by an occupant of the vehicle. Thereafter, the program is ended (step A07).

A specific example of a combination of the respective drive conditions (the drive amounts of the cooling fan 19) is described below. For example, as shown in FIG. 3, in the first map (A), the drive amount (duty value) of the cooling fan 19 is set to “60” in the case in which the battery temperature is “50° C.”, and in the second map (B), the drive amount (duty value) of the cooling fan 19 is set to “20” in the case in which the drive amount (drive level) of the blower fan 9 is “2”. Furthermore, in the third map (C), the drive amount (duty value) of the cooling fan 19 is set to “50” in the case in which the vehicle speed is “50 km/h”, and in the fourth map (D), the drive amount (duty value) of the cooling fan 19 is set to “40” in the case in which the engine speed is “2000 rpm”. In this case, the maximum drive amount (duty value) of the cooling fan 19 according to the second map (B) to the fourth map (D) is “50”, whereas the drive amount (duty value) of the cooling fan 19 according to the first map (A) is “60”. Therefore, the drive amount (duty value) of “50” according to the third map (C) is adopted, and the cooling fan 19 is driven on the basis of this drive amount.

As a result, in this example, the drive of the cooling fan 19 is controlled in consideration of the battery temperature (battery state), the drive level (air conditioning state) of the blower fan 9 of the air conditioner 3, the vehicle speed (vehicle state), and the engine speed (engine state). Thereby, the opportunity of cooling the drive battery 12 can be increased by using the background noise of the electric vehicle, and the drive battery 12 can be cooled in the state in which the driving sound of the cooling fan 19 is obscured by the background noise.

Furthermore, the first map (A) to the fourth map (D), each of which is used for obtaining the respective drive conditions (the drive amounts of the cooling fan 19) in each of the first drive condition determination means 16A to the fourth drive condition determination means 16D, are stored in the cooling fan control means 16. Therefore, the drive conditions (the drive amounts of the cooling fan 19) of the cooling fan 19 can be simply obtained by selecting one of the maps according to each of the above-described states.

The cooling fan control device according to the present invention can also be applied to the field of stationary electron microscopes, a buffer power source for wind power generation, a night-time power storage device for home use, and the like.

The following is a list of reference numbers indicated in the figures and described in the corresponding text:
1 Engine
2 Drive motor
3 Air conditioner
4 Battery system
5 Engine control means
6 Engine speed detection means
7 Vehicle speed detection means
8 Inverter
9 Blower fan
10 Air conditioning control means
11 Blower fan drive amount detection means
12 Drive battery
13 Battery temperature measurement means
14 Battery current detection means
15 Battery state detection means
16 Cooling fan control means
16A First drive condition determination means
16B Second drive condition determination means
16C Third drive condition determination means
16D Fourth drive condition determination means
16E Storage means
18 Communication line
19 Cooling fan
20 Control line

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A cooling fan control device for use in a vehicle in which a drive battery and an engine, both serving as drive energy sources, and an air conditioner of the vehicle are mounted, and in which a cooling fan for cooling the drive battery is provided, the cooling fan control device comprising:
temperature measurement means for detecting a temperature of the drive battery;
blower fan drive amount detection means for detecting a drive amount of a blower fan of the air conditioner;
vehicle speed detection means for detecting a vehicle speed;
engine speed detection means for detecting an engine speed; and
cooling fan control means provided with:
first drive condition determination means for obtaining a drive amount of the cooling fan according to the temperature of the drive battery,
second drive condition determination means for obtaining a drive amount of the cooling fan according to the drive amount of the blower fan of the air conditioner,
third drive condition determination means for obtaining a drive amount of the cooling fan according to the vehicle speed, and
fourth drive condition determination means for obtaining a drive amount of the cooling fan according to the engine speed,
wherein the cooling fan control means compares the largest drive amount among the drive amounts of the cooling fan which are respectively obtained by the second drive condition determination means, the third drive condition determination means, and the fourth drive condition determination means, with the drive amount of the cooling fan which is obtained by the first drive condition determination means, and drives the cooling fan in correspondence with the smaller drive amount of the cooling fan.

2. The cooling fan control device according to claim 1, wherein the cooling fan control device means includes storage means for storing therein:
a first map used in the first drive condition determination means for obtaining the drive amount of the cooling fan,
a second map used in the second drive condition determination means for obtaining the drive amount of the cooling fan,
a third map used in the third drive condition determination means for obtaining the drive amount of the cooling fan, and
a fourth map used in the fourth drive condition determination means for obtaining the drive amount of the cooling fan.
